(19) United States
(12) Patent Application Publication
(10) Pub. No.: US 2022/0252872 A1
(43) Pub. Date: Aug. 11, 2022

(54) Optical Element Mounting Method

(71) Applicant: Nippon Telegraph and Telephone Corporation, Tokyo (JP)

(72) Inventors: Sohan Kawamura, Musashino-shi, Tokyo (JP); Yuichi Akage, Musashino-shi, Tokyo (JP); Takashi Sakamoto, Musashino-shi, Tokyo (JP); Soichi Oka, Musashino-shi, Tokyo (JP)

(21) Appl. No.: 17/629,246

(22) PCT Filed: Aug. 1, 2019
(86) PCT No.: PCT/JP2019/030358

§ 371 Date: Jan. 21, 2022

(51) Int. Cl. G02B 27/00; G02B 7/00

(52) U.S. Cl. CPC G02B 27/0012; G02B 7/00

(57) ABSTRACT

An optical device mounting method for mounting an optical device to a holding mechanism, including a step of designing a shape of the optical device in accordance with a stress expected to be applied to the optical device, such as not to cause the optical device to deform or to inhibit deformation to achieve desired performance.

### TECHNICAL FIELD

The present invention relates to an optical device, and more particularly to a mounting method thereof.

### BACKGROUND ART

Optical devices such as lenses, mirrors, and diffractive elements are widely used not only in domestic appliances but also in industrial control devices or production equipment, or research equipment and measurement instruments. They also find wide applications in 3D printers that have seen increased demand particularly in recent years, 3D profile measuring instruments, and metal processing that uses several kW-level laser light.

Among these optical devices, one that is used for the processing with a laser beam of several kW entails an issue of heat generated in the optical device by absorption of a few percentages of energy due to the difficulty to achieve 100% transmission rate or reflection rate of laser light. This results in a thermal lens effect such as, for example, a change in focal distance due to lens expansion, which makes it difficult to perform the processing with desired precision for a prolonged time. This issue arises with mirrors or diffractive optical elements, too. For example, the focal distance may change due to deformation in a concave mirror or a convex mirror caused by thermal expansion, and a similar phenomenon may occur in a diffractive optical element, too.

To prevent such a phenomenon (or thermal lens effect in a wider sense), it is often the case with a machining process that uses several kW-level laser light to cool the optical device. Specifically, in the case of cooling a flat mirror, for example, the back side of a reflection surface is cooled. Depending on the method, however, the cooling may induce distortion in the reflection surface contrarily.

In the case of adopting air cooling as the cooling method, for example, even though the flat mirror that reflects a laser beam of 10 kW has a reflection rate of 99%, the flat mirror will absorb 100 W energy, which causes a temperature rise of the flat mirror and thermal expansion, resulting in a thermal lens effect.

Depending on the material and thickness of the flat mirror, several hundreds liters per minute of air may have to be blown to the flat mirror, and a force of several hundreds N may be required to mount the flat mirror firmly so that it is not shaken by the air.

Retaining a flat mirror with such a large force may sometimes cause distortion in the flat mirror already when the mirror is retained.

FIG. 1 is a diagram for explaining an example of how a reflective diffractive optical element, as an example of a conventional optical device, is mounted to a laser processing system. In FIG. 1(a), the reflective diffractive optical element 101 includes a cooling mechanism 201 on the back side. With its lateral sides oriented in the y-axial direction, the element is set at an angle so that the reflection surface faces down and left to incident light 301 of a laser beam coming from the left side of the drawing in the z-axial direction and emits reflected light 302 in the x-axial direction. The reflected light 302 forms an interference pattern of diffracted light 303 on a laser-irradiated object (not shown) below or near the focal point in accordance with the characteristics determined by a diffraction pattern formed on the surface of the reflective diffractive optical element 101.

An example of a rectangular light intensity distribution of the interference pattern of the diffracted light 303 is shown in the lower part of FIG. 1(a). As illustrated in FIG. 1(b), the light intensity distribution along the x-axial direction of a cross section of the incident light 301 beam is Gaussian, and as illustrated in FIG. 1(c), the incident light 301 beam has a circular cross sectional shape (profile) in the x-y plane. The reflective diffractive optical element 101 converts the Gaussian distribution of the incident light 301 into diffracted light 303 with a rectangular distribution to enable efficient laser irradiation of an object.

### (Cooling Mechanism and Heating Mechanism)

Another countermeasure against heat generation of the reflective diffractive optical element is to use a viscous fluid that is not air such as, for example, water or oil as the cooling medium.

FIG. 2 shows a perspective view and a cross-sectional view illustrating a conventional cooling mechanism that uses a viscous fluid cooling for a reflective diffractive optical element.

In FIG. 2(a), the reflective diffractive optical element 101 is retained and held as a lid of a viscous fluid holding part 203 (container) that holds the viscous fluid by a frame component 202 for pressing an optical device that forms part of the cooling mechanism (optical device holding mechanism).

As shown in the cross-sectional view in FIG. 2(b), an inlet 204 of the viscous fluid and an outlet 205 of the viscous fluid are provided in opposite side faces of the container 203 holding the viscous fluid 401, which is flowing in the direction of arrows by the pressure applied on the inlet 204 side.

For the required cooling ability to be achieved by the cooling using the viscous fluid, it is sometimes necessary to increase the flow rate of the viscous fluid. However, raising the drive pressure at the inlet 204 in order to increase the flow rate of the viscous fluid may cause warpage in the reflective diffractive optical element 101 due to the increased pressure of the viscous fluid inside the container 203, because of which the focal distance may change and optical processing with desired precision may be rendered difficult.

Sometimes the components making up the cooling mechanism and the material of the optical device have largely different linear expansion coefficients, which causes deformation in the optical device and makes it impossible to configure the optical system as desired.

Furthermore, when the optical device sometimes needs to be operated at a predetermined temperature, for example, there is provided a heat-retaining or heating mechanism that uses a heater or a heating fluid instead of a cooling mechanism, depending on the installation environment. In such cases, too, the optical device may undergo deformation for similar reasons due to thermal expansion (contraction), drive pressure, and retention stress, because of which configuration of a desired optical system may not be possible.

### CITATION LIST

### Patent Literature

[PTL 1] JP H09-174274A

### SUMMARY OF THE INVENTION

### Technical Problem

The present invention provides a mounting method that solves an issue of changes in optical characteristics such as focal distance of an optical device such as the ones described above because of warpage caused by pressure or stress applied as a result of cooling, heating, or by other causes.

The present invention was made to resolve this issue, with an object to provide a mounting method that allows an optical device to be operated (used) with desired precision.

### Means for Solving the Problem

To achieve this object, one example of embodiment of the present invention includes the following configurations.

According to one aspect, it is a mounting method wherein the optical device to be mounted is designed such that a portion functioning as the optical device is made thin while its surrounding portion is made thick, so as to increase rigidity to withstand stress or pressure applied to the optical device by cooling, temperature rise by light irradiation, or retention, to allow the optical device to have the desired function.

Alternatively, it is a mounting method wherein the stress or pressure expected to be applied to the optical device when mounted due to cooling, heating, or retention is measured or estimated in advance, and the optical device to be mounted is distorted by design such that the optical device will be in the shape having a desired function when the stress or pressure measured or estimated in advance is actually applied to the optical device when mounted.

It is also a mounting method wherein, in the case of the cooling or heating mechanism using a viscous fluid, the pressure of the viscous fluid is controlled, or in the case of using a Peltier element, the linear expansion coefficient of the substance of the Peltier element is made substantially equal to the linear expansion coefficient of the material of the optical device.

One example of embodiment of the present invention can further include the following configurations.

### (Configuration 1)

An optical device mounting method for mounting an optical device to a holding mechanism, including a step of designing a shape of the optical device in accordance with a stress expected to be applied to the optical device, such as not to cause the optical device to deform or to inhibit deformation to achieve desired performance.

### (Configuration 2)

The optical device mounting method according to Configuration 1, wherein thickness is varied between a portion having a function of an optical device and a portion not having the function to prevent distortion of the optical device.

### (Configuration 3)

An optical device mounting method for mounting an optical device to a holding mechanism, including a step of designing a shape of the optical device in a way intentionally distorted such as to cancel out any deformation that is measured or estimated in accordance with a stress expected to be applied to the optical device in a mounted state, so that desired performance is achieved when mounted.

### (Configuration 4)

An optical device mounting method that uses a cooling or heating mechanism therewith, including a step of making a linear expansion coefficient of a material used for the cooling or heating mechanism substantially equal to a linear expansion coefficient of a material of the optical device, to prevent deformation of the optical device.

### (Configuration 5)

An optical device mounting method for mounting an optical device, used with a cooling or heating mechanism that uses a viscous fluid, including a step of varying a structure between a portion having a function of the optical device and a portion not having the function to prevent optical device performance from being compromised as a result of deformation of the optical device caused by a drive pressure for the viscous fluid.

### (Configuration 6)

An optical device mounting method for mounting an optical device, used with a viscous fluid holding part forming a cooling or heating mechanism that uses a viscous fluid, including a step of setting pressure to a value that does not cause deformation of the optical device by adjusting at least one or all of a cross-sectional area of an inlet or an outlet and a flow path length of the viscous fluid in the viscous fluid holding part.

### (Configuration 7)

An optical device mounting method for mounting an optical device to a holding mechanism, including a step of increasing thickness of an outer peripheral portion of the optical device including points at which the optical device is retained to configure an optical system in which the optical device will not be distorted by a holding force and influence of temperature fluctuations or vibration will not be received.

### Effects of the Invention

The optical device mounting method described above can realize mounting of an optical device whereby changes in focal distance due to warpage caused by pressure or stress applied in a cooling or heating method can be prevented.

### BRIEF DESCRIPTION OF DRAWINGS

FIG. 1 is a diagram for explaining an example of how a reflective diffractive optical element, as one example of a conventional optical device, is mounted.

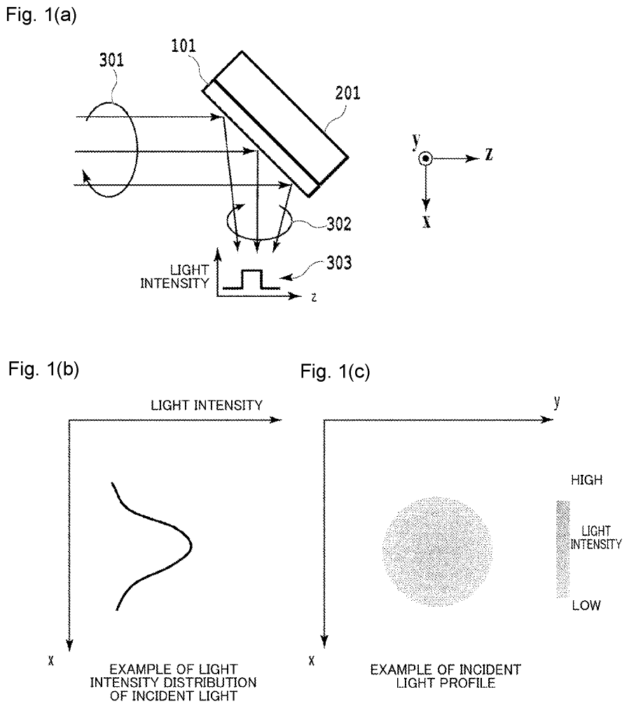

FIG. 2 shows a perspective view and a cross-sectional view illustrating a conventional cooling mechanism that uses a viscous fluid cooling.

FIG. 3 shows a perspective view and a cross-sectional view of an optical device illustrating Embodiment 1 of the present invention.

FIG. 4 shows a perspective view and a cross-sectional view of an optical device illustrating Embodiment 2 of the present invention.

### DESCRIPTION OF EMBODIMENTS

Hereinafter, embodiments of the present invention will be described in detail.

### Embodiment 1

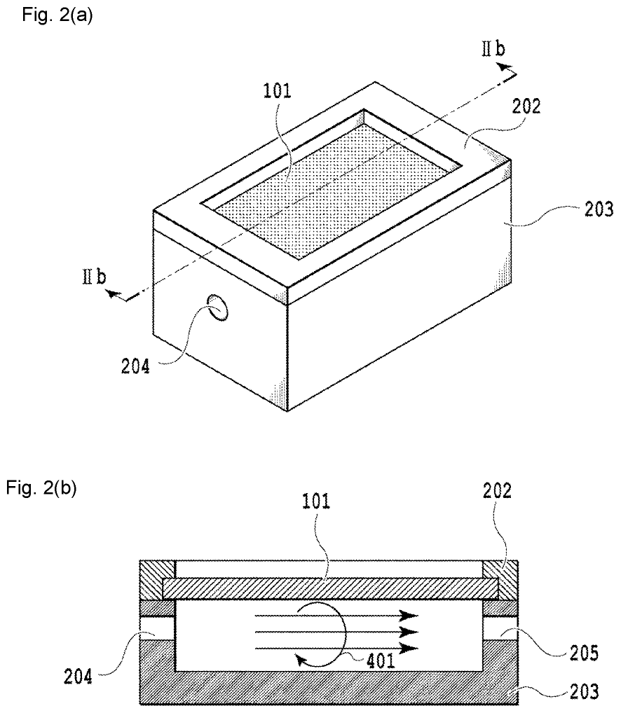

Let us consider a circulatory system for the cooling mechanism of FIG. 2: The viscous fluid 401 flowing out of the outlet 205 flows through a pipe such as a hose (not shown) to be collected in a thermostatic tank that regulates the temperature of the viscous fluid, from which the viscous fluid 401 is pumped into a pipe to flow into the container 203 from the inlet 204 in FIG. 2. The drive pressure Pₒᵤₜ at the inlet 204 required for causing the viscous fluid 401 to flow out from the outlet 205 (assuming it is atmospheric) in such a circulatory system can be calculated by the following equation, by applying the Bernoulli's principle:

$$Math . 1$$

$${P}_{out} = {( \frac{Flow amount}{Discharge coefficient \times Flow path area} )}^{2} \times \frac{Density}{2} + \begin{matrix}Pressure loss \\ ( per unit length )\end{matrix} \times Flow path length + \begin{matrix}Atmospheric Pessure \\ ( hydraulic pressure )\end{matrix} \qquad Equation ( 1 )$$

The first term of this equation (1) is the dynamic pressure as determined by the Bernoulli's principle, the second term is the total pressure loss required for passage of the flow path, and the third term is the static pressure. The flow path area is the cross-sectional area of the outlet 205, the density is the density of the viscous fluid, and the discharge coefficient is a proportional coefficient determined by the viscous fluid.

If the amounts of inflow and outflow are both 2 L/sec, for example, the pressure of the viscous fluid 401 in FIG. 2 is substantially equal to the Pₒᵤₜ defined above, meaning the optical device 101 is subjected to Pₒᵤₜ. The present invention allows for mounting of the optical device in a way that inhibits deformation of the optical device against such a pressure.

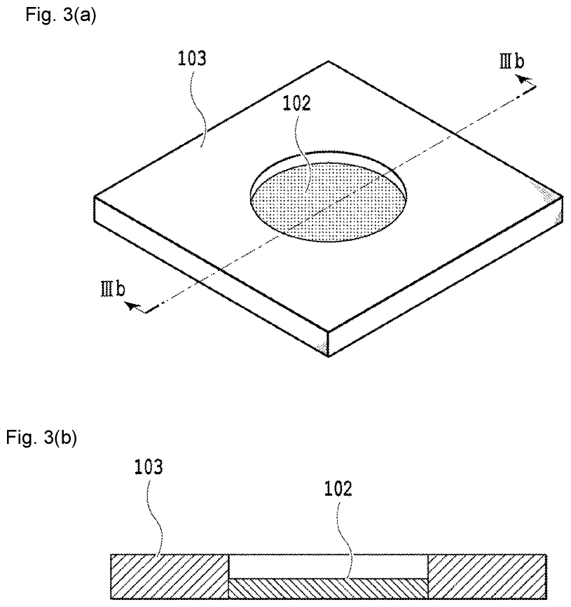

FIG. 3 shows a perspective view (a) and a cross-sectional view (b) of an optical device illustrating Embodiment 1 of the present invention. In FIGS. 3(a) and (b), a surface that is functional as an optical device, e.g., a mirror if the device is a flat mirror, and a micro-structured surface if the device is a diffractive optical element, referred to as functional surface 102 (portion having a function of an optical device), is a thin circular part in the center, which is formed thinner than the surrounding non-functional surface 103 (portion not having the function of the optical device) that does not have the function of the optical device.

The optical device with the configuration used in the mounting method according to Embodiment 1 of the present invention illustrated in FIG. 3, which is mounted to the cooling mechanism 201, has a non-functional surface 103 with a thickness large enough not to warp under the Pₒᵤₜ defined above, or able to inhibit deformation. When mounted, the optical device 101 is pressed down and held by the frame component 202 of the cooling mechanism, but typically, the non-functional surface 103 of the optical device is formed such as to withstand the pressure or stress associated with the mounting and to prevent distortion, or to inhibit deformation, of the optical device. For reference, the tolerable limit of deformation is about several tens meters in terms of the radius of curvature of the optical device, for example.

Making a portion that functions as an optical device of the optical device thin while making the surrounding parts thick, or conversely, making a portion that functions as an optical device thick while making the surrounding parts thin, can increase the overall rigidity against the stress or pressure applied to the optical device, so that the optical device can be mounted in the form that has the desired function.

In other words, the point of the present invention is to design the shape of the optical device in accordance with the stress expected to be applied to the optical device, such as not to cause the optical device to deform or to inhibit deformation to achieve desired performance when mounted to a mechanism that holds the optical device. Varying the thickness of the optical device, for example, between a portion having the function as the optical device and a portion not having the function, can enhance the overall rigidity and prevent distortion of the optical device.

Set in an optical system with the configuration described above, processing was performed using a laser beam of 10 kW, which was successfully carried out with desired precision, without any thermal lens effect occurring.

### Embodiment 2

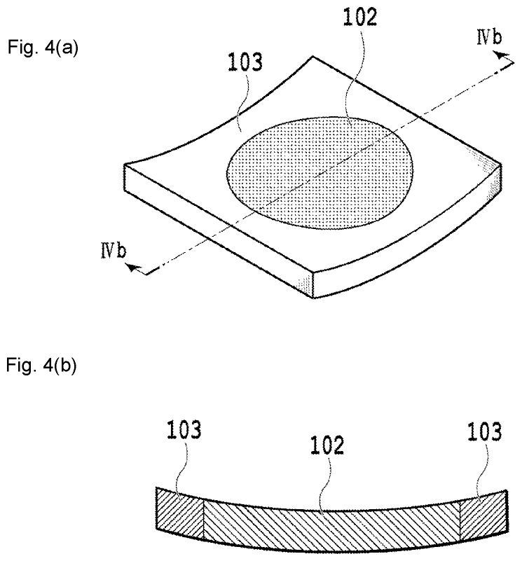

FIG. 4 shows a perspective view (a) and a cross-sectional view (b) of an optical device used in a mounting method according to Embodiment 2 of the present invention. If the same level of pressure as that of Embodiment 1 is applied to the optical device 101 in the cooling mechanism of the conventional configuration in FIG. 2, and if the optical device 101 is a flat mirror, the pressure as applied in Embodiment 1 will cause the optical device, which is a few millimeter-thick metal member, to warp into a shape like a convex mirror, and can no longer function as a flat mirror.

Accordingly, in the optical device mounting method in Embodiment 2 of the present invention illustrated in FIG. 4, deformation of the optical device caused by pressure and/or stress applied to the optical device in the mounted state is measured, or deformation is calculated and estimated by calculations from physical properties of the metal material of the optical device or the like, and the optical device is designed in a shape resembling a concave mirror in anticipation of the pressure and/or stress applied when actually mounted or during use so that the optical device will function as a flat mirror.

In FIG. 4, similarly to FIG. 3, the functional surface 102 is a portion having the function of the optical device, and the non-functional surface 103 is a portion that does not have the function of the optical device. In the configuration of Embodiment 1 in FIG. 3, the thickness is varied from one portion to another so as to increase the overall rigidity of the optical device. In Embodiment 2 in FIG. 4, instead of increasing rigidity, the shape is designed in anticipation and in consideration of deformation so that when mounted, the pressure or the like applied during operation or use cancels the deformation to achieve a desired, optimal shape.

In other words, it is an optical device mounting method wherein the optical device shape is designed in a way intentionally distorted such as to cancel out any deformation that is measured or estimated in accordance with a stress expected to be applied to the optical device in a mounted state, so that desired performance is achieved when mounted.

This optical device mounting method according to Embodiment 2 is equally applicable to address the stress or deformation caused by not only a cooling mechanism but also a heat-retaining or heating mechanism that uses a heater or a heating fluid, for example.

With the configuration described above, processing was performed using a laser beam of 10 kW, which proved that the optical device of Embodiment 2 functioned as a flat mirror as desired, and the processing was carried out successfully as desired, without any thermal lens effect occurring.

### Embodiment 3

Embodiment 3 of the present invention adopts a mounting method wherein a Peltier element that works on current to control temperature is attached to the back side of the optical device and used as a cooling mechanism to suppress a temperature rise of the optical device.

However, an optical system could not be configured as desired due to warpage of the optical device caused by thermal stress, resulting from a difference in coefficient of linear thermal expansion between the optical device and the ceramics used for the Peltier element.

Accordingly, in the mounting method of Embodiment 3, the material of the optical device was changed to one that has more or less the same linear expansion coefficient as that of the ceramics of the Peltier element. As a result, no warpage occurred in the optical device, and an optical system could be configured as desired. The linear expansion coefficient of the material used for the cooling or heating mechanism is substantially matched with the linear expansion coefficient of the material of the optical device, to prevent distortion of the optical device. The range of linear expansion coefficient values assumed to be substantially the same depends on the thickness and the like of the two materials and cannot be uniquely defined. Generally, the thicker, the easier to suppress warpage or distortion, and therefore wider the range of values assumed to be equal.

The optical device mounting method according to this embodiment is equally applicable to address the stress or deformation caused by not only a cooling mechanism but also a heat-retaining or heating mechanism that uses a heater or a heating fluid, for example.

### Embodiment 4

In the configuration of Embodiment 1 in which a diffractive optical element is mounted in a cooling mechanism, the element is warped into a state like a convex mirror because of the pressure during use, resulting in the focal distance of 30 cm being increased by 10 cm. This necessitated a mechanism for moving the optical device to adjust the focus and resulted in bulkiness of the apparatus.

Accordingly, in the mounting method in Embodiment 4 of the present invention, this warpage (radius of curvature) is calculated in advance, and the diffractive optical element is fabricated such that the focal distance will be 30 cm when the radius of curvature is the determined value, and mounted and used. The result was that processing was possible with the focal distance of 30 cm even under pressure during use, which made the moving mechanism for the optical device unnecessary.

The optical device mounting method according to this embodiment is equally applicable to address the stress or deformation caused by not only a cooling mechanism but also a heat-retaining or heating mechanism that uses a heater or a heating fluid, for example.

### Embodiment 5

In the mounting method according to Embodiment 5 of the present invention, the drive pressure Pₒᵤₜ of the cooling mechanism in the configuration of Embodiment 1 applied to the optical device was reduced by increasing the flow path area in Equation (1), or by shortening the flow path length, or by doing both, while keeping the same flow rate and the same cooling capability, the result being that no warpage occurred in the optical device and processing was successfully performed as desired.

Namely, it is an optical device mounting method in which the pressure is set to a value that does not cause deformation of the optical device by a configuration with an adjustment made to at least one or all of the cross-sectional area of the inlet or outlet of the viscous fluid, and the flow path length.

The optical device mounting method according to this embodiment is equally applicable to address the stress or deformation caused by not only a cooling mechanism but also a heat-retaining or heating mechanism that uses a heater or a heating fluid, for example.

### Embodiment 6

Even when no cooling function is required, if the optical device is as large as 20 cm or more in diameter, for example, a force of several tens N or more is required for retaining the optical device in a manner not affected by temperature fluctuations or vibration. It has been known that such a holding force causes distortion in the optical device.

According to the mounting method of Embodiment 6 of the present invention, an optical system not susceptible to temperature fluctuations, vibration, or holding force was configured, with an outer peripheral portion of the optical device including the points at which the optical device is retained being increased in thickness so that the optical device will not be distorted by the holding force.

### INDUSTRIAL APPLICABILITY

As described above, the optical device mounting method according to the present invention allows for mounting of an optical device whereby changes in characteristics of the optical device resulting from deformation of the optical device caused by drive pressure of a cooling or heating mechanism, thermal stress, holding force and the like can be prevented.

### REFERENCE SIGNS LIST

101 Optical device
102 Functional surface (portion having a function of an optical device)
103 Non-functional surface (portion not having a function of an optical device)
201 Cooling or heating mechanism
202 Frame component
203 Viscous fluid holding part (container)
204 Inlet
205 Outlet
301 Incident light
302 Reflected light
303 Diffracted light (light intensity distribution)
401 Viscous fluid

1. An optical device mounting method for mounting an optical device to a holding mechanism, comprising a step of:
designing a shape of the optical device in accordance with a stress expected to be applied to the optical device, such as not to cause the optical device to deform or to inhibit deformation to achieve desired performance.

2. The optical device mounting method according to claim 1, wherein
thickness is varied between a portion having a function of the optical device and a portion not having the function to prevent distortion of the optical device.

3. An optical device mounting method for mounting an optical device to a holding mechanism, comprising a step of:
designing a shape of the optical device in a way intentionally distorted such as to cancel out any deformation that is measured or estimated in accordance with a stress expected to be applied to the optical device in a mounted state, so that desired performance is achieved when mounted.

4. An optical device mounting method that uses a cooling or heating mechanism therewith, comprising a step of:
making a linear expansion coefficient of a material used for the cooling or heating mechanism substantially equal to a linear expansion coefficient of a material of the optical device, to prevent deformation of the optical device.

5.-7. (canceled)
